(19) United States
(12) Patent Application Publication
(10) Pub. No.: US 2011/0200208 A1
(43) Pub. Date: Aug. 18, 2011

(54) APPARATUS AND METHOD FOR TRANSMITTING SOUND THROUGH NONLINEAR MEDIA

(75) Inventors: Jae Hoon Shim, Daejeon (KR); Sung Weon Kang, Daejeon (KR); Sung Eun Kim, Seoul (KR); Jung Hwan Hwang, Daejeon (KR); Chang Hee Hyoung, Daejeon (KR); Jin Kyung Kim, Daejeon (KR); In Gi Lim, Daejeon (KR); Hyung Il Park, Daejeon (KR); Kyung Soo Kim, Daejeon (KR); Jung Bum Kim, Daejeon (KR); Tae Wook Kang, Daejeon (KR); Ki Hyuk Park, Daejeon (KR)

(73) Assignee: Electronics and Telecommunications Research Institute, Daejeon (KR)

(21) Appl. No.: 12/808,707

(22) PCT Filed: Sep. 25, 2008
(86) PCT No.: PCT/KR2008/005687

§ 371 Date: Jun. 17, 2010

(30) Foreign Application Priority Data
Dec. 20, 2007 (KR) 10-2007-0134374
Jul. 14, 2008 (KR) 10-2008-0068224

(51) Int. Cl. H04B 15/00

(52) U.S. Cl. 381/94.1

(57) ABSTRACT

Provided are an apparatus and method for transmitting sound through a nonlinear medium. The apparatus includes a pre-distorter for previously distorting a sound signal to compensate for distortion to be caused by a frequency characteristic of the nonlinear medium in a transmission process of the sound signal, a sigma-delta modulator for modulating the pre-distorted sound signal into a signal having two signal levels, a high-frequency modulator for multiplying the modulated signal by a carrier wave having a higher frequency than an audio frequency band to shift the modulated signal to a carrier frequency band and generate a high-frequency modulated signal, and a transmitter for converting the high-frequency modulated signal into a sound wave signal suited to be transmitted through the nonlinear medium and transmitting the sound wave signal.

### TECHNICAL FIELD

The present invention relates to an apparatus and method for transmitting sound, and more particularly, to an apparatus and method for transmitting a sound signal through a nonlinear medium.

The present invention is derived from research performed as a part of the IT R&D program of MIC/IITA. [2006-S-072-02, Human Body Communication Controller SoC].

### BACKGROUND ART

In the past, the most general method of transmitting a sound signal was to directly transmit the signal through air using a human's mouth or a sound generation device such as a speaker.

The method can easily transmit a good-quality sound signal. However, the method is susceptible to noise, and the signal is transmitted to others as well as the corresponding receiver.

To solve these problems, technology for transferring a signal to only a desired spot using an ultrasonic signal array has been developed. However, a transmitting device based on this technology has a large size and is not suitable for a mobile environment.

In addition, there is a method of wirelessly transmitting a signal using a Radio Frequency (RF), infrared rays or others and replaying sound using a signal receiving device, earphones, etc., but the receiving device must be equipped near the hearing organ of a human body.

Furthermore, there is technology for transferring a signal using a human body as a communication channel without a receiving device. However, a system for transmitting sound through a human body on the basis of this technology requires two transmitters, and transmits two signals that basically use the same carrier frequency but are modulated differently, thus having a complex constitution and large power consumption.

Also, problems are caused by differences in frequency and phase between the two transmitters and a path difference between the two transmission signals.

### DISCLOSURE OF INVENTION

### Technical Problem

The present invention is directed to providing an apparatus and method for transmitting sound through a nonlinear medium, such as a human body, using only one transmitter and one signal source without a receiving device.

### Technical Solution

One aspect of the present invention provides an apparatus for transmitting sound through a nonlinear medium, comprising: a pre-distorter for previously distorting a sound signal to compensate for distortion to be caused by a frequency characteristic of the nonlinear medium in a transmission process of the sound signal; a sigma-delta modulator for modulating the pre-distorted sound signal into a signal having two signal levels; a high-frequency modulator for multiplying the modulated signal by a carrier wave having a higher frequency than an audio frequency band to shift the modulated signal to a carrier frequency band and generate a high-frequency modulated signal; and a transmitter for converting the high-frequency modulated signal into a sound wave signal suited to be transmitted through the nonlinear medium, and transmitting the sound wave signal.

Another aspect of the present invention provides a method of transmitting sound through a nonlinear medium, comprising: previously distorting a sound signal to compensate for distortion to be caused by frequency characteristics of a transmitting device and the nonlinear medium in a transmission process of the sound signal; sigma-delta modulating the pre-distorted sound signal into a signal having two signal levels; multiplying the modulated signal by a carrier wave having a higher frequency than an audio frequency band to generate a high-frequency modulated signal; and converting the high-frequency modulated signal into a sound wave signal suited to be transmitted through the nonlinear medium, and transmitting the sound wave signal.

### Advantageous Effects

According to the present invention, one transmitting apparatus transmits a sound signal using a nonlinear characteristic of a medium and a characteristic of a hearing organ without a receiving device. Since no receiving device is required, freedom of action can be improved, and a system can be easily constructed.

In addition, since one transmitting apparatus and one transmission signal are used, a technical problem that may be caused when two transmission signals are used is not caused, and power consumption is reduced. Also, the simple constitution of the apparatus leads to a reduction in production cost.

Furthermore, the number of levels of transmission signals is limited to two using sigma-delta modulation, such that a high-efficiency nonlinear amplifier can be used.

### BRIEF DESCRIPTION OF THE DRAWINGS

FIG. 1 is a block diagram of an apparatus for transmitting sound according to an exemplary embodiment of the present invention;

FIG. 2 illustrates an example of a sound signal to be transmitted by an apparatus for transmitting sound according to an exemplary embodiment of the present invention;

FIG. 3 illustrates a result obtained by sigma-delta modulating the sound signal shown in FIG. 2 according to an exemplary embodiment of the present invention;

FIG. 4 illustrates frequency components of the result obtained by sigma-delta modulating the sound signal shown in FIG. 2 according to an exemplary embodiment of the present invention; and

FIG. 5 illustrates an example of the waveform of a sound signal modulated at high frequency according to an exemplary embodiment of the present invention.

### MODE FOR THE INVENTION

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art.

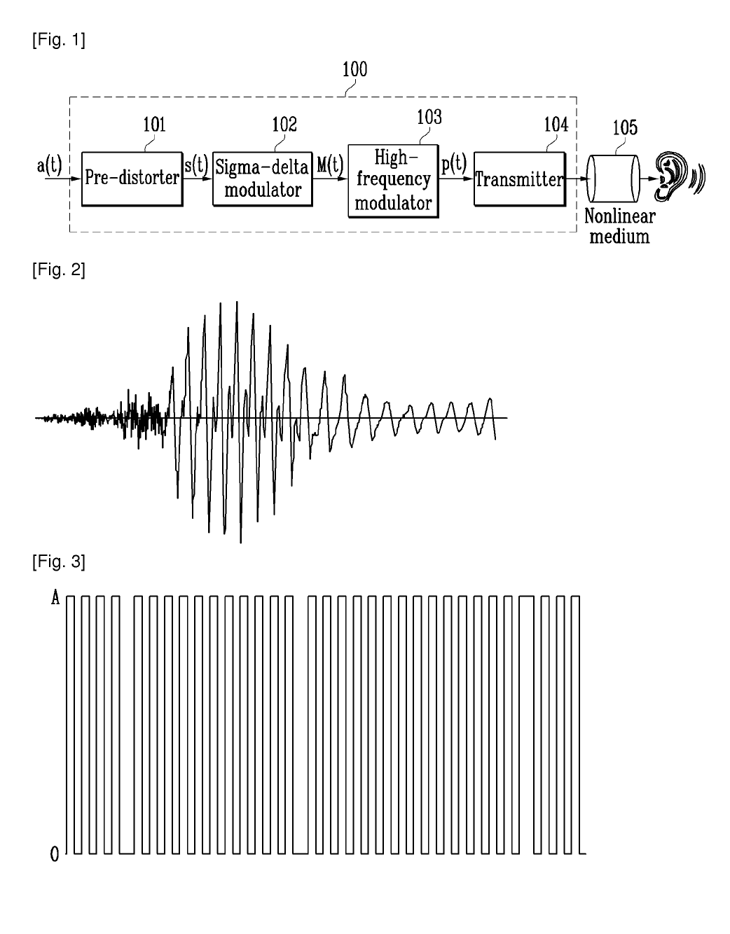

FIG. 1 is a block diagram of an apparatus for transmitting sound according to an exemplary embodiment of the present invention, and FIG. 2 illustrates an example of a sound signal to be transmitted by an apparatus for transmitting sound according to an exemplary embodiment of the present invention.

Referring to FIG. 1, an apparatus 100 for transmitting sound according to an exemplary embodiment of the present invention includes a pre-distorter 101, a sigma-delta modulator 102, a high-frequency modulator 103 and a transmitter 104.

The pre-distorter 101 functions to previously distort a sound signal a(t) of an audio frequency band to be transmitted in consideration of frequency characteristics of the transmitter 104 and a nonlinear medium 105. This is intended to compensate for distortion that may be caused while the sound signal a(t) passes through the transmitter 104 and the nonlinear medium 105.

The sigma-delta modulator 102 functions to modulate a sound signal s(t) previously distorted by the pre-distorter 101 into a signal M(t) having two signal levels of 0 and A. The sigma-delta modulator 102 processes the sound signal s(t) at a frequency larger than the double of the bandwidth of the sound signal s(t), and quantization noise caused by the process is suppressed at low frequency, that is, within the audio frequency band through a loop filter and amplified at high frequency out of the audio frequency band through the loop filter. FIG. 3 illustrates a result obtained by one-bit second-order sigma-delta modulating the sound signal shown in FIG. 2.

Here, the signal M(t) output from the sigma-delta modulator 102 may be expressed using different transfer functions of the sound signal s(t) and a quantization noise q(t) as follows.

M(t)=STF(s(t))+NTF(q(t)) [Equation 1]

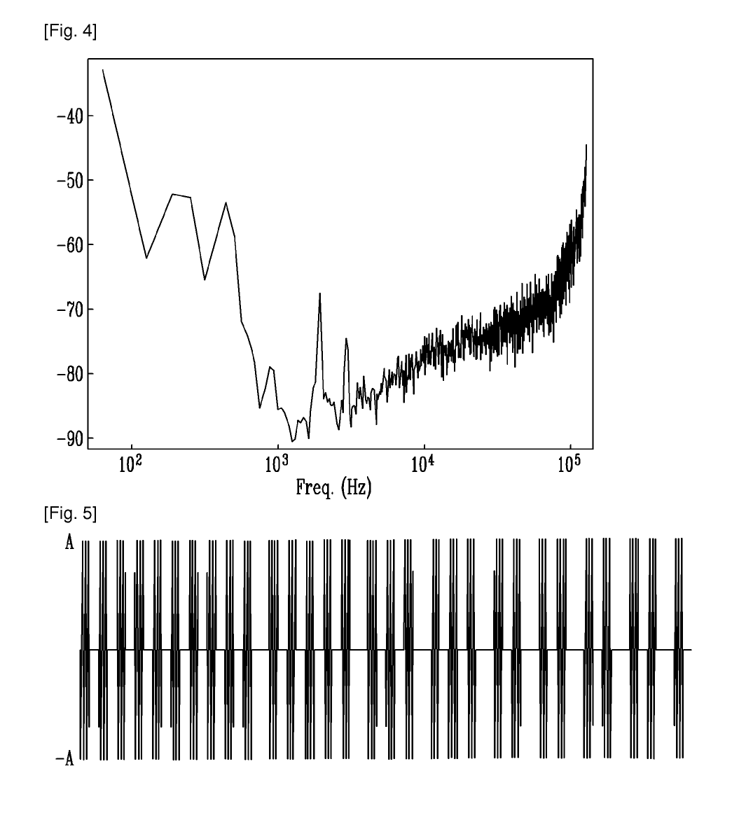

Here, a Signal Transfer Function (STF) is simply a delayer or has a low-pass characteristic, and a Noise Transfer Function (NTF) has a high-pass characteristic. In an exemplary embodiment, use of a one-bit quantizer increases the quantization noise q(t) but sufficiently reduces quantization noise within the audio frequency band in comparison with the signal to be transmitted as illustrated in FIG. 4.

FIG. 4 illustrates frequency components of the result obtained by sigma-delta modulating the sound signal shown in FIG. 2 according to an exemplary embodiment of the present invention.

A sampling frequency and a loop filter order used in the sigma-delta modulator 102 may be determined according to the quality of a sound signal to be transmitted.

Meanwhile, the pre-distorter 101 and the sigma-delta modulator 102 are separately implemented in the apparatus 100 for transmitting sound according to an exemplary embodiment, but the sigma-delta modulator 102 may have an STF that can complement or replace the distortion function of the pre-distorter 101.

The high-frequency modulator 103 multiplies the signal M(t) output from the sigma-delta modulator 102 by a carrier wave signal having a higher frequency than the audio frequency to shift the signal M(t) to a band around the carrier frequency, thereby generating a high-frequency modulated signal p(t). This is expressed by an equation below.

p(t)=M(t)cos w_{c}t [Equation 2]

Here, cos w_{c}t denotes a carrier component.

FIG. 5 illustrates an example of the waveform of an output signal modulated at high frequency according to an exemplary embodiment of the present invention.

The transmitter 104 functions to amplify the high-frequency modulated signal p(t) output from the high-frequency modulator 103 in consideration of attenuation occurring when the high-frequency modulated signal p(t) passes through the nonlinear medium 105 and to convert the amplified signal into a sound wave signal. The transmitter 104 includes an amplifier and a transducer for conversion into a sound wave signal.

A process in which a sound signal, transmitted by the above-described apparatus, is received by the hearing organ of a human body through a nonlinear medium without a receiving device will be described below. When a medium has a nonlinear transfer function, components such as the second, third and fourth powers of a transmission signal are shown together with the transmission signal at a receiving end.

For example, the high-frequency modulated signal p(t)=M(t)cos w_{c}t itself output from the high-frequency modulator 103 is out of the audio frequency band and thus cannot be sensed by the hearing organ. However, the square

$${p}^{2} ( t ) = {M}^{2} ( t ) {cos}^{2} {w}_{c} t = {M}^{2} ( t ) \frac{1 + cos 2 {w}_{c} t}{2}$$

of the signal has a component M²(t) within the audio frequency band and thus can be sensed.

When the signal M(t) is an Amplitude Modulation (AM) signal, that is, M(t)=1+ms(t), a signal within the audio frequency band becomes M²(t)=1+2 ms(t)+m²s²(t) (m denotes a modulation index).

Here, s²(t) denotes signal distortion. To prevent such distortion, a square root signal of the AM signal, that is,

M(t)={square root over ((1+ms(t)))}

may be used. Here, 1+ms(t) must not be a negative. However, even in this case, there are terms such as the fourth power of the signal p(t), etc., and thus distortion of the signal still exists.

On the other hand, the signal M(t) modulated by the sigma-delta modulator 102 according to an exemplary embodiment of the present invention is expressed by two signal levels of 0 and A. In addition, even if the components such as the second, third and fourth powers are generated due to the nonlinearity of a medium, only the level of the signal is changed, and the signal is not distorted. Furthermore, quantization noise out of the audio frequency band amplified by the sigma-delta modulator 102 is automatically removed by the low-pass characteristic of the hearing organ.

As a result, the apparatus for transmitting sound according to an exemplary embodiment of the present invention can transfer a sound signal without significant distortion not using a receiving device. Also, the signal p(t) modulated at high frequency according to an exemplary embodiment of the present invention has only two signal levels of 0 and A, and thus it is possible to use a high-efficiency nonlinear amplifier.

Meanwhile, when the signal p(t)=M(t)cos w_{c}t is transmitted through the medium of air, a signal of approximately

$$r ( t ) = \frac{{d}^{2}}{d {t}^{2}} {M}^{2} ( t )$$

is shown in the audio frequency band due to the nonlinearity of the medium. The result is not the signal M²(t) but is the second-order derivative of M²(t) with respect to time. This means that frequency distortion corresponding to 12 dB/oct occurs in the frequency domain. In addition, different sort of distortion may be caused by frequency characteristics of the amplifier and the transducer of the transmitter 104. To cancel out such distortion, a sound signal is previously distorted by the pre-distorter 101 in consideration of frequency characteristics of the transmitter 104 and the nonlinear medium 105 according to an exemplary embodiment of the present invention.

While the invention has been shown and described with reference to certain exemplary embodiments thereof, it will be understood by those skilled in the art that various changes in form and details may be made therein without departing from the spirit and scope of the invention as defined by the appended claims.

1. An apparatus for transmitting sound through a nonlinear medium, comprising:
a pre-distorter for previously distorting a sound signal to compensate for distortion to be caused by a frequency characteristic of the nonlinear medium in a transmission process of the sound signal;
a sigma-delta modulator for modulating the pre-distorted sound signal into a signal having two signal levels;
a high-frequency modulator for multiplying the modulated signal by a carrier wave having a higher frequency than an audio frequency band to shift the modulated signal to a carrier frequency band and generate a high-frequency modulated signal; and
a transmitter for converting the high-frequency modulated signal into a sound wave signal suited to be transmitted through the nonlinear medium, and transmitting the sound wave signal.

2. The apparatus of claim 1, wherein the pre-distorter also distorts the sound signal to compensate for distortion caused by a frequency characteristic of the transmitter.

3. The apparatus of claim 1, wherein the sigma-delta modulator processes the pre-distorted sound signal at a higher frequency than a double of a bandwidth of the sound signal and converts the pre-distorted sound signal into the signal having two signal levels.

4. The apparatus of claim 1, wherein quantization noise caused while the sigma-delta modulator converts the pre-distorted sound signal into the signal having two signal levels is suppressed at a low frequency within the audio frequency band through a loop filter.

5. The apparatus of claim 1, wherein the sigma-delta modulator has a signal transfer function capable of complementing or replacing a signal distortion function of the pre-distorter.

6. The apparatus of claim 1, wherein the transmitter comprises:
an amplifier for amplifying the high-frequency modulated signal in consideration of attenuation occurring when the high-frequency modulated signal passes through the nonlinear medium; and
a transducer for converting the amplified signal into the sound wave signal.

7. A method of transmitting sound through a nonlinear medium, comprising:
previously distorting a sound signal to compensate for distortion to be caused by frequency characteristics of a transmitting device and the nonlinear medium in a transmission process of the sound signal;
sigma-delta modulating the pre-distorted sound signal into a signal having two signal levels;
multiplying the modulated signal by a carrier wave having a higher frequency than an audio frequency band to generate a high-frequency modulated signal; and
converting the high-frequency modulated signal into a sound wave signal suited to be transmitted through the nonlinear medium, and transmitting the sound wave signal.

8. The method of claim 7, further comprising:
amplifying the high-frequency modulated signal to a sufficient level for preparing for signal attenuation occurring when the high-frequency modulated signal passes through the nonlinear medium.
